(19) United States
(12) Patent Application Publication
(10) Pub. No.: US 2008/0146269 A1
(43) Pub. Date: Jun. 19, 2008

(54) System and method for antenna resource management in non-harmonized RF spectrum

(76) Inventors: Fahd B. Pirzada, Austin, TX (US); Liam B. Quinn, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/639,158

(22) Filed: Dec. 14, 2006

(51) Int. Cl. H04M 1/00

(52) U.S. Cl. 455/552.1

(57) ABSTRACT

Methods and systems are disclosed for antenna resource management in a non-harmonized RF spectrum that enable sharing of antenna structures for multiple wireless applications across different frequency bands in a global market environment and the harmonization of wireless devices in a close proximity environment. Antenna resources are allocated and managed using management software in an environment having multiple antenna resources for use with multiple wireless device types. Management software may control switching logic to retarget the antennas for different association with different types of wireless devices. Policies for selecting wireless devices types may be driven based upon one or more of location awareness, spectrum awareness, and marketing preferences. The wireless devices can be laptop computers, other portable devices, desktop computers, information handling systems, or the like.

### TECHNICAL FIELD OF THE INVENTION

The present disclosure relates to a system and method for enabling sharing of antenna structures for multiple wireless applications across different frequency bands in a global market environment and the harmonization of wireless devices in a close proximity environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems incorporate multi-band antenna structures and switching mechanisms. The adoption of integrated wireless technologies into mobile platforms continues to push design and architectural challenges for system designers and integrators. An existing architectural model for antenna structures does not scale with these technologies. The variations in global spectrum allocated across the different wireless options add to the complexity in terms of spectrum harmonization for multiple wireless devices in a given environment. The amount of wireless devices and applications in mobile computing platforms continues to expand. The frequency spectrum and regulatory constraints imposed by local and national agencies usually requires changes in transmit/receive power budgets and frequency allocation to mitigate interference with incumbent devices, services and applications.

Some information handling systems use cognitive radio to handle multiple antenna resources in multiple wireless devices. Cognitive radio technology enables wireless devices and antenna structures to sense the adjacent RF environment, to provide antenna tuning and frequency agility to accommodate its underlying wireless technology and avoid interference.

Prior art systems may include wireless configurations having an RF coupler/switches to implement a dipole antenna in notebooks. Another current art system considers sharing antenna resources between four radios, but does not consider implications of antennas for multiple spectrum allocations. There is a need for an information handling system for use with multiple antennae associated with multiple wireless devices that provides a method and system for antenna resource management in a non-harmonized RF spectrum.

### SUMMARY OF THE INVENTION

The present disclosure describes an information handling system for antenna resource management in a non-harmonized RF spectrum having multiple antenna and management software for allocating antenna resources, wherein antenna resources can be managed by management software. Policies may be driven based from one or more of location awareness, spectrum awareness, and marketing preferences. The wireless device can be a laptop computer, desktop computer, or an information handling system.

In one embodiment, the present disclosure includes a method of selecting wireless device access in an information handling system. The method may comprising providing multiple antenna resources; providing multiple wireless devices; and associating at least some of the wireless devices with the antenna resources based upon management software, wherein the association is based at least in part upon policies that are impacted by location awareness, spectrum awareness, and/or marketing preferences. In another method, the wireless device may be a wireless radio and the method may further include the utilizing of cognitive radio techniques to affect the location awareness, spectrum awareness or marketing preferences. As described below, other features and variations can be implemented, if desired, and a related systems can be utilized, as well.

In another embodiment, the present disclosure provides an information handling system for antenna resource management in a non-harmonized RF spectrum. The system may comprise multiple wireless radio resources; multiple antenna resources coupled to the multiple wireless radio resources; and management software for selectably associating the wireless radio resources with the antenna resources according to at least in part location awareness, spectrum awareness, and/or marketing preferences. As described below, other features and variations can be implemented, if desired, and a related method can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram of an information handling system with a wireless device;

FIG. 2 is an illustrative table of marketing preferences for utilizing multiple wireless standards showing primary and secondary sources of network access;

FIG. 3 is a flowchart of the steps involved for antenna resource management in a non-harmonized RF spectrum; and

FIG. 4 is a diagram of hardware for antenna resource management in a non-harmonized RF spectrum.

### DETAILED DESCRIPTION OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

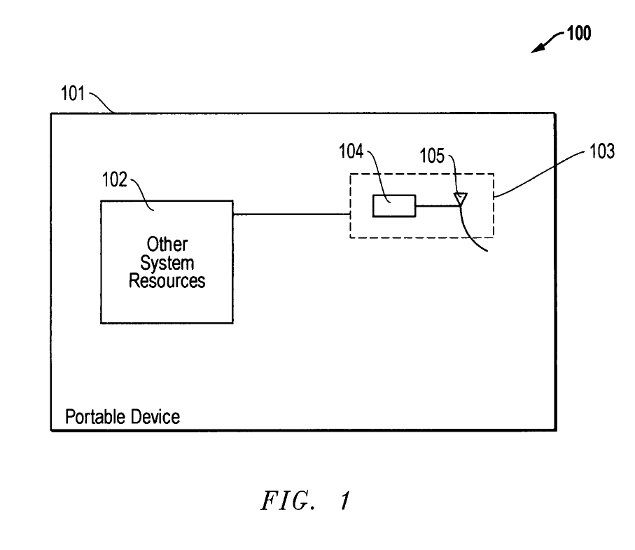

The present disclosure provides systems and methods for antenna resource management in a non-harmonized RF spectrum. FIG. 1 shows a block diagram of an information handling system 100 with a device 101 that may communicate through wireless transmissions with other devices, systems, networks, etc. For example, the device 101 may be a notebook or laptop computer having system resources 102, such as a CPU, memory, network interface, device drivers, operating system, and the like. In one embodiment, wireless device access is provided through the use of wireless resources 103. The wireless resources 103 may be compatible with one or more wireless standards and may include multiple RF front ends and antennae. Thus, the wireless resources 103 may include wireless radio circuitry resources 104 and antenna resources 105 and the antenna resources 105 may be one or more wireless antennas and the wireless radio circuitry resources 104 may be one or more wireless radios. Thus a plurality of antennas and a plurality of wireless radios may be provided so that access may be made to a variety of different wireless standards and frequencies. For example standards and frequencies may be utilized such as GSM/W-CDMA: 800/900 MHz and 1800/1900/2100 MHz; WLAN or Wi-Fi: 2.4 GHz and 5 GHz; Mobile WiMax: 2.3 GHz, 2.5 GHz, 3.5 GHz and 5.8 GHz; DVB-H: 1.4-1.7 GHz; MediaFlo: 700 MHz; Bluetooth: 2.4 GHz; UWB: 3.1-10.6 GHz. It will be recognized that the techniques described herein are not limited to any particular wireless standard or frequency and may be applicable to a wide variety of current or future wireless techniques. As discussed more below, management software may be used to allocate the antenna and radio resources. In one example, the management software may request Time Zone/Country information from the system resources 102 and set the wireless modes of operations based upon a known regulatory environment and available resources for that location. Wireless resource policies can be driven based from one or more of location awareness, spectrum awareness, and marketing preferences. If the regulatory domain has changed, the user or system 100 may change the Time Zone/Country information and the management software may automatically configure the wireless modes of operation according to a locations regulatory domain. If the regulatory domain has not changed, the system may continue under the previous wireless settings. Cognitive radio techniques may be optionally utilized to detect the current wireless environment, any non-compliant transmissions, or optional available modes and to prompt the management software regarding the status of a regulatory domain.

The wireless resource policies that may be driven based from one or more of location awareness, spectrum awareness, and marketing preferences may be used to allocate/retarget the antennae and radio resources to a desired one or more wireless standards and/or frequencies to utilize. For example, the polices may be utilized to select a primary wireless access standard and/or frequency and one or more secondary wireless access standards and/or frequencies. Thus, the wireless management software may control the wireless resources to allocate/retarget the radios and antennas for different use cases and applications. For example, the available antenna resources may be configured to conform with the wireless standards to which connectivity is desired. These marketing preferences are desired because wireless devices within close proximity interfere with each other. This co-device interference may be mitigated with the use of spectral filtering and efficient modulation techniques. However the best way to control this interference is to limit the use of wireless devices based on use cases.

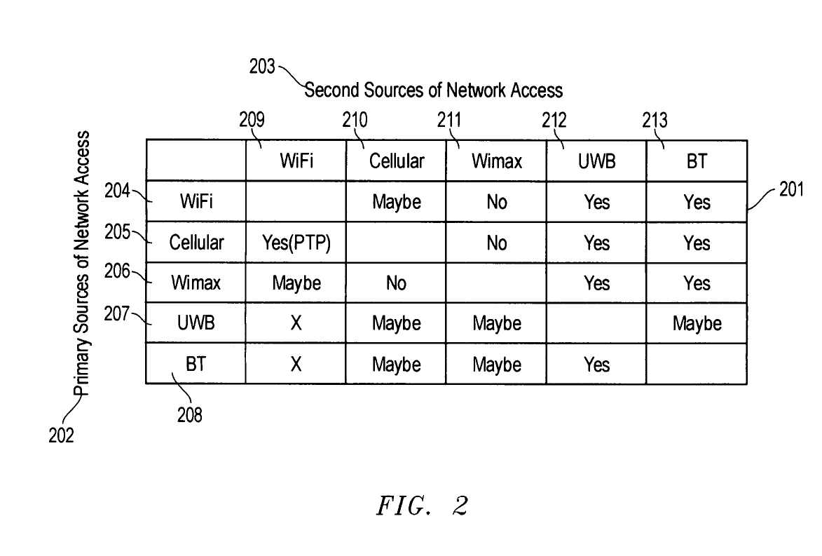

FIG. 2 shows a table 201 of exemplary marketing preferences that could be established for concurrent wireless usage of wireless resources. Thus, multiple wireless standards with primary and secondary sources of network access are shown. The table 201 in FIG. 2 shows exemplary primary sources of network access 202 in a vertical column, including WiFi 204, cellular 205, Wimax 206, ultra wide band (UWB) 207, and Bluetooth (BT) 208. Also shown on the table 201 are secondary sources of network access or cable replacement 203 in a horizontal column, including WiFi 209, cellular 210, Wimax 211, UWB 212, and BT 213. The table 201 sets out marketing preferences for concurrent wireless usage. For example, if a cellular device 205 is used for primary network connectivity 202 (internet access), the WiFi device 209 may be used for file-sharing in infrastructure or ad-hoc modes. If the Wimax device 206 is used for primary network connectivity 202, the cellular device 210 should not be required for simultaneous network connectivity. Marketing preferences may be configured such that certain combinations of resources are allowed for primary and secondary sources of network access (for example a YES in the table), certain combinations are not allowed (a NO in the table) and certain combinations are optionally allowed (a MAYBE in the table). The management software may identify the use cases under which certain antennas can be re-allocated. For example, if the UWB/Bluetooth interface is being used as the primary source of internet connectivity, then Wimax or cellular as a secondary connection may be relatively unimportant.

It will be understood that the potential sources of network access are merely exemplary and other standards currently available now or in available in the future may be utilized. Moreover, the combinations of primary and secondary sources and their allowable status are also merely exemplary. Further, the requirements shown in FIG. 2 could vary by country or even within different locations of a given country.

As mentioned above, marketing preferences such as the exemplary preferences shown in FIG. 2 may also be combined other information in order to determine the allocation of the wireless resources. For example, awareness of the current conditions of the spectrum environment may affect the allocation of the wireless resources. The current conditions of the spectrum environment may, in one example, be obtained utilizing cognitive radio techniques. Similarly, location information may affect the allocation of wireless resources. For example, certain wireless standards may be unavailable in certain locations, may be restricted from use in certain locations, etc. As used herein, the preferences described with respect to FIG. 2 are indicated to be marketing preferences. The term marketing preferences is not however meant to be limited “marketing” in a traditional sense but rather merely reflects some set of preferences or policies established by system user, system supplier, other entity or system, or even the system itself. Thus, such preferences may be established by a system supplier as part of the system definition or alternatively the policies or preferences may be created by the user themselves or may be created by the system itself based upon various available criteria.

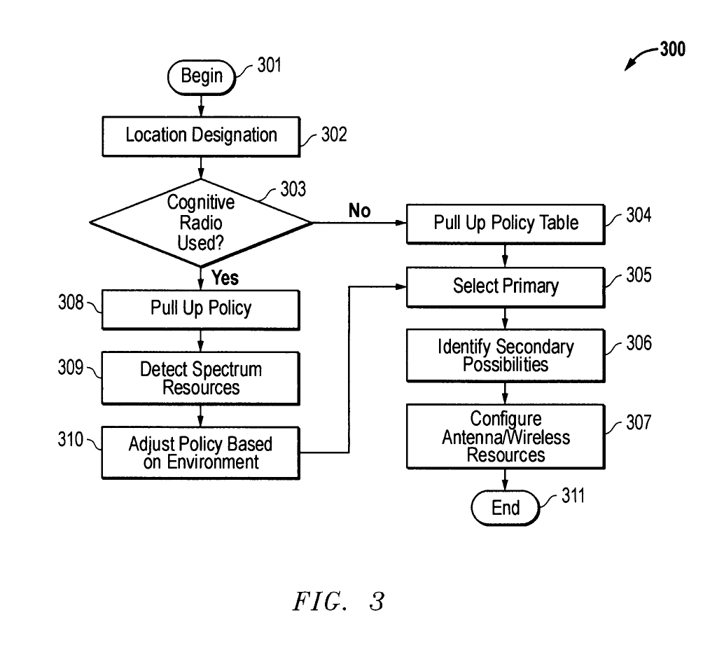

FIG. 3 shows a flowchart 300 of the steps involved for antenna resource management in a non-harmonized RF spectrum. The process begins at step 301. At step 302 a location may be designated. The location designation may be made be any of a number of techniques. For example, the location may be obtained from the system resources (such as for example from the Time Zone/Country information maintained in the system resources). Alternatively, the location may be obtained from the use of Global Positioning Systems (GPS) resources or even through manual user intervention.

A determination may then be made regarding whether cognitive radio is used at step 303 (as shown in FIG. 3 an embodiment that allows the potential use of cognitive radio techniques is shown, however, the techniques provided herein may be utilized even if cognitive radio techniques are unavailable). If No, a policy table is pulled up, step 304. The policy table may include data such as the marketing preferences shown in FIG. 2 and/or location specific policies. It cognitive radio is utilized at step 303, the process may move to step 308 for obtaining a policy table. The condition of the spectrum environment /resources may then be detected at step 309. At step 310, the policy table may be adjusted based upon the conditions detected at step 309. For example, if a given location has a preferred primary network access standard but the detection step determines that the condition of the particular access spectrum is unavailable, congested, or poor quality, etc., the policy table may be adjusted to reflect such data. In addition, the use of cognitive radio to identify wireless spectrum utilization that is outside of the expected spectrum as permitted under regulatory standards may indicate that the location of the system has changed from the last prior location designation. A determination of such a change may prompt changes to the location designation (either automatically changed or changed by user intervention) and/or changes to the policy table as shown in step 310.

After a policy table is established, such as in step 304 or 310, control may then move to step 305. In step 305 a primary network access may be selected. The primary network access may be selected based upon one or more of a variety of the location, spectrum and marketing factors. For example, the primary network access may be selected solely upon the location information. Alternatively, the primary network access may be selected based upon a combination of the location and marketing preferences. In yet another alternative the primary network access may be selected based upon location and the detected spectrum conditions. These are just some of the exemplary combinations of information that may be utilized to select the primary network and it will be recognized that other combinations may also be utilized. Secondary network access possibilities are then identified in step 306. As with step 305, the secondary network access possibilities may be based upon a wide range of combinations of information as established and may be established in the policy table. The antenna/wireless resources may then be configured in step 307 based on the selections of steps 305 and 306. Then the process ends at step 311. It will be recognized that the order of the steps of the technique of FIG. 3 are merely exemplary and various steps may be performed in an alternative order while still achieving the benefits of the techniques described herein.

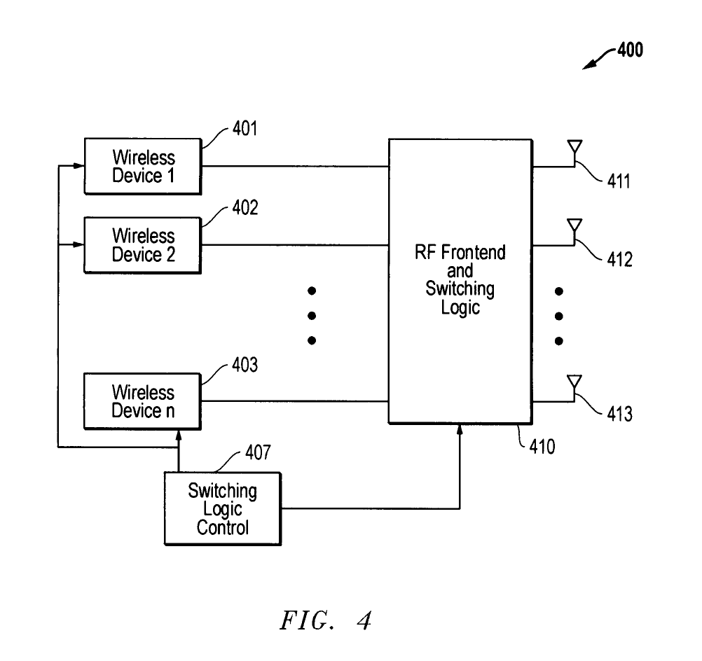

The techniques described herein may be implemented in a wide variety of hardware configurations. FIG. 4 illustrates one such exemplary hardware configuration. It will be recognized, however, that other hardware configurations may be utilized. As shown in FIG. 4 hardware for wireless radio and antenna resource management in a non-harmonized RF spectrum 400. A wireless radio device 401 connects to RF front end and switching logic 410. A second wireless radio device 402 may also be connected to the RF front end and switching logic 410. Further as shown, N radio devices may be similarly coupled to the RF front end and switching logic 410 as indicated by wireless radio device 403. The wireless radio devices may be compatible with the same or different wireless standards. For example, wireless radio device 401 may be compatible with Wi-Fi standards, wireless radio device 402 may be compatible with cellular standards and wireless radio device 404 may be compatible with Bluetooth standards. These combinations described however will be recognized to be merely exemplary. M antennae 411, 412, and 413 may be coupled to the RF front end and switching logic 410. Though shown in FIG. 4 with regards to three radios and three antennae, the number of radios N and the number of antennae M do not need to match and the numbers N and/or M may be more or less than three. For example, it will be understood that one antenna could serve multiple wireless radio device types or be re-tunable for a different radio types. Therefore, the number of wireless devices can exceed the number of antennae.

The antennae 411, 412, and 413 may be similar in structure, may be specially configured to be compatible with one or more selected wireless standards or may be selectable configurable for various wireless standards. In operation, the RF front end and switching logic may selectable couple a given wireless radio device to a given antennae. Which radio device and which antennae are coupled together may be dependent upon a number of factors including for example the standard of the selected radio device, whether the radio device is a primary or secondary source, the current configuration of the antennae and/or what other radios and antennae are currently being utilized.

A switching logic module or control 407 is coupled to the wireless devices 401, 402, 403 and to RF front end and switching logic 410. The switching logic module or control 407 receives inputs from the management software to select the appropriate wireless radio devices (for example based upon the location awareness, spectrum awareness, and marketing preferences described above) and also provides corresponding control inputs to the RF front end and switching logic 410 to select the appropriate antenna to the appropriate wireless radio device. In this way the policies established by the wireless management software may be implemented. The switching logic may be as simple as disabling the unused antennas or more complicated, such as retuning antennas for operation in a different band. The switching logic may be realized as a separate module that serves as the hub of all antennae cabling in the mobile platform. Such an implementation provides more complete control over the functionality or tuning of each and every antenna.

It will be recognized that a device or system utilizing the techniques described herein provides a device or system that is advantageously adaptable for use in different global markets. Thus, a single device or system may be provided for use in different global markets without requiring specific hardware or software configurations for the particular market. In this manner a single product may therefore be appropriate for sale in multiple markets even if the wireless environments of these markets varies.

Though described herein with regards to specific embodiments that reference RF wireless it will be recognized that other wireless technologies, for example optical signaling or other wireless signaling may also be utilized with the concepts described herein.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method of selecting wireless device access in an information handling system, comprising:
providing multiple antenna resources;
providing multiple wireless devices;
associating at least some of the wireless devices with the antenna resources based upon management software, wherein the association is based at least in part upon policies that are impacted by marketing preferences.

2. The method of claim 1, wherein policies are further impacted by location awareness.

3. The method of claim 2, wherein the location awareness is provided from a GPS locator.

4. The method of claim 2, wherein the location awareness is providee from an operating system time zone or country setting.

5. The method of claim 1, wherein policies are further impacted by location awareness and spectrum awareness.

6. The method of claim 1, wherein policies are further impacted by spectrum awareness.

7. The method of claim 6, wherein the spectrum awareness is provided by cognitive radio techniques.

8. The method of claim 1, wherein the marketing preferences include primary and secondary marketing preferences.

9. The method of claim 1, wherein the information handling system is a portable device.

10. The method of claim 1, wherein primary and secondary access designations are provided to the wireless devices.

11. A method of selecting wireless device access in an information handling system, comprising:
providing multiple antenna resources;
providing multiple wireless radio devices;
associating at least some of the wireless devices with the antenna resources based upon management software, wherein the association is based at least in part upon policies that are impacted by marketing preferences;
utilizing cognitive radio techniques to affect the marketing preferences.

12. The method of claim 11, wherein the policies are further impacted by location awareness.

13. The method of claim 11, wherein the policies are further impacted by location awareness and spectrum awareness.

14. The method of claim 11, wherein the policies are impacted by spectrum awareness.

15. The method of claim 11, wherein the marketing preferences include primary and secondary access designations provided to the wireless devices.

16. The method of claim 15, wherein a plurality of secondary access designations are provided for one primary access designation.

17. The method of claim 11, wherein a given primary access designation for a first wireless radio device excludes a second wireless radio device from being designated as a secondary access device.

18. The method of claim 11, wherein the cognitive radio techniques provide spectrum awareness.

19. The method of claim 11, wherein the cognitive radio techniques prompt changing a location setting.

20. An information handling system for antenna resource management in a non-harmonized RF spectrum, comprising:
multiple wireless radio resources;
multiple antenna resources coupled to the multiple wireless radio resources; and
management software for selectably associating the wireless radio resources with the antenna resources according to at least in part marketing preferences.

21. The information handling system of claim 20, further comprising switching logic coupled between the wireless radio resources and the multiple antenna resources, the switching logic being responsive to the management software.

22. The information handling system of claim 20, wherein at least one of the wireless radio resources is a cognitive radio.

23. The information handling system of claim 22, wherein the cognitive radio is utilized to affect the marketing preferences.

24. The information handling system of claim 20, wherein selectable association is based at least in part on location awareness

25. The information handling system of claim 20, wherein the information handling system is a portable information handling system.
